(19) United States
(12) Patent Application Publication
(10) Pub. No.: US 2007/0070044 A1
(43) Pub. Date: Mar. 29, 2007

(54) Key touchpad module

(75) Inventors: I-Hau Yeh, Hsinchu City (TW); Tso-Chieh Yang, Cingshuei Township (TW)

Correspondence Address: TROXELL LAW OFFICE PLLC;SUITE 1404, 5205 LEESBURG PIKE, FALLS CHURCH, VA, 22041, US

(73) Assignee: Elan Microelectronics Corp.

(21) Appl. No.: 11/358,212

(22) Filed: Feb. 22, 2006

(30) Foreign Application Priority Data
Sep. 23, 2005 (TW) 094216400

(51) Int. Cl. G09G 5/00

(52) U.S. Cl. 345/169

(57) ABSTRACT

The present invention provides a touchpad module which obtains a touching sensibility and a uniform transmission of light to avoid non-linear problem by using a soft touch pad.

### FIELD OF THE INVENTION

The present invention relates to a touchpad module; more particularly, relates to obtaining a touching sensibility of a touching feeling, a low non-linearity, and a uniform transmission of light with a key set and a touchpad.

### DESCRIPTION OF THE RELATED ART

Please refer to FIG.7. A prior art, “A touchpad module for handwriting and keying”, is proclaimed in Taiwan, where the touchpad module 5 comprises a touchpad 51 to sense touching motion; and a key set 52 stuck to the touchpad 51 and comprised of a plurality of keys 521. Under a keying mode, a key 521 of the key set 52 is pressed down and is sensed by the touchpad 51 to return a corresponding key value; and, under a coordinate sensing mode, the above touching motion to the touchpad 51 is sensed to return a coordinate value. Thus, the touch pad module 5 obtains a key value under a keying mode or a coordinate value under a coordinate sensing mode.

Although the prior art comprises a keying function as well as a coordinate sensing function, the user cannot clearly sense the substantiality of the key. Besides, a general touchpad is non-penetrable. An improvement made to the general touchpad is applied to a touching feeling module 6 having a touch pad 61, as shown in FIG. 8, where first holes 62 (shaped as a square with an edge of about 5 millimeter) are dug on the touchpad 61 for the light of the LED (light emitting diode ) at the bottom to be transmitted out; and second holes 63 (shaped as a circle with a diameter of about 5 millimeter) are inserted with special keys to obtain hand feel (as shown in FIG. 9). Yet these holes output non-linear touching sensibilities. When a human hand is touching a touchpad, the area occupied comprises a diameter of about 0.8 cm (centimeter). And, for achieving high resolution and linear feeling, a distance between two sensing lines on the touch pad is smaller than 0.4 cm. Hence, the first holes 62 and the second holes 63 directly affect the sensibility of the touchpad. The more the first holes 62, the more serious the non-linear sensibility and the lower the resolution. In addition, the distribution of the second holes 63 may produce an uneven light-transmission of LEDs. Hence, the prior art does not fulfill users' requests on actual use.

### SUMMARY OF THE INVENTION

The main purpose of the present invention is to provide a touch pad module with a uniform penetrability, a touching feeling and a linear touching sensibility.

To achieve the above purpose, the present invention is a key touch pad module, comprising an insulating material area, a soft touchpad and a key set, where the soft touch pad is a FPC (flexible printed circuit) and the soft touchpad is stuck to and between the insulating material area and the key set. Accordingly, a novel key touchpad module is obtained.

### BRIEF DESCRIPTIONS OF THE DRAWINGS

The present invention will be better understood from the following detailed description of the preferred embodiment according to the present invention, taken in con junction with the accompanying drawings, in which

FIG. 1 is a structural view of a first preferred embodiment according to the present invention;

FIG. 2 is a partial structural view of the first preferred embodiment according to the present invention;

FIG. 3A is a partial cross-sectional view of the first preferred embodiment according to the present invention;

FIG. 3B is a partial state-of-use view of the first preferred embodiment according to the present invention;

FIG. 4A is a partial cross-sectional view of a second preferred embodiment according to the present invention;

FIG. 4B is a partial state-of-use view of the second preferred embodiment according to the present invention;

FIG. 5 is a structural view of a third preferred embodiment according to the present invention;

FIG. 6 is a partial structural view of the third preferred embodiment according to the present invention;

FIG. 7 is a perspective view of a prior art;

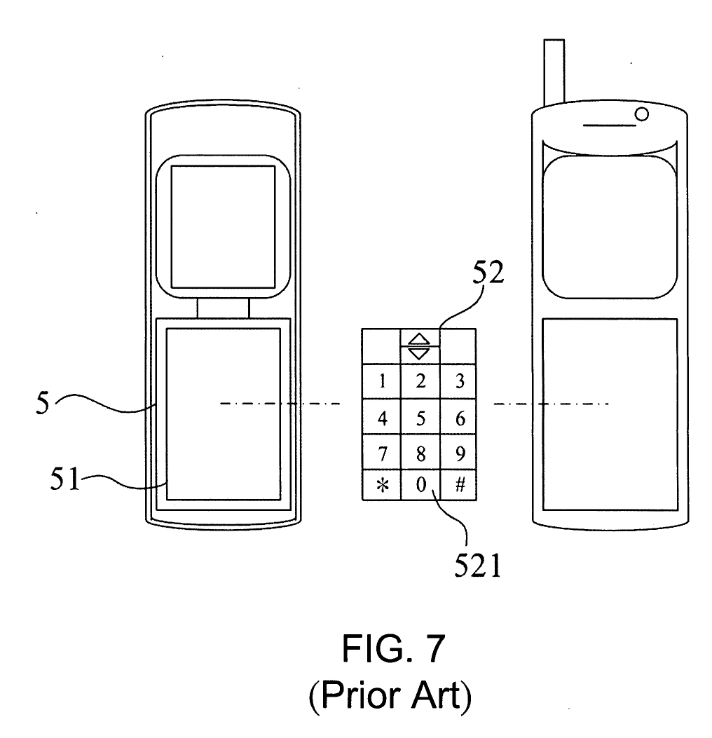

FIG. 8 is a view showing a touchpad module of a prior art; and

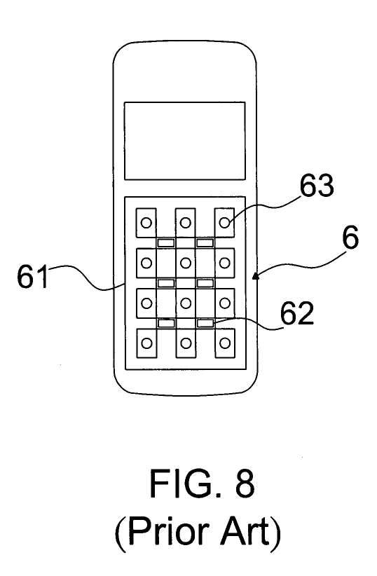

FIG. 9 is a partial cross-sectional view showing the touchpad module of the prior art.

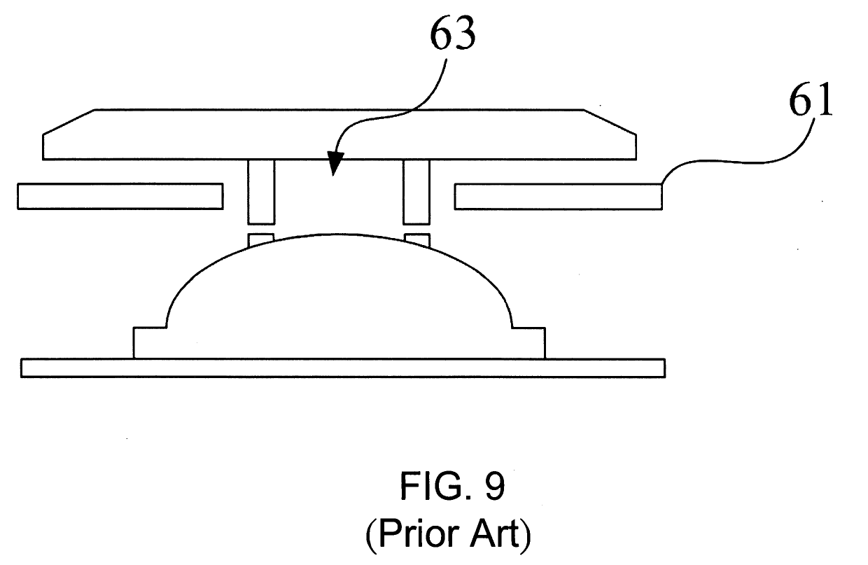

### DESCRIPTION OF THE PREFERRED EMBODIMENT

The following description of the preferred embodiment is provided to understand the features and the structures of the present invention.

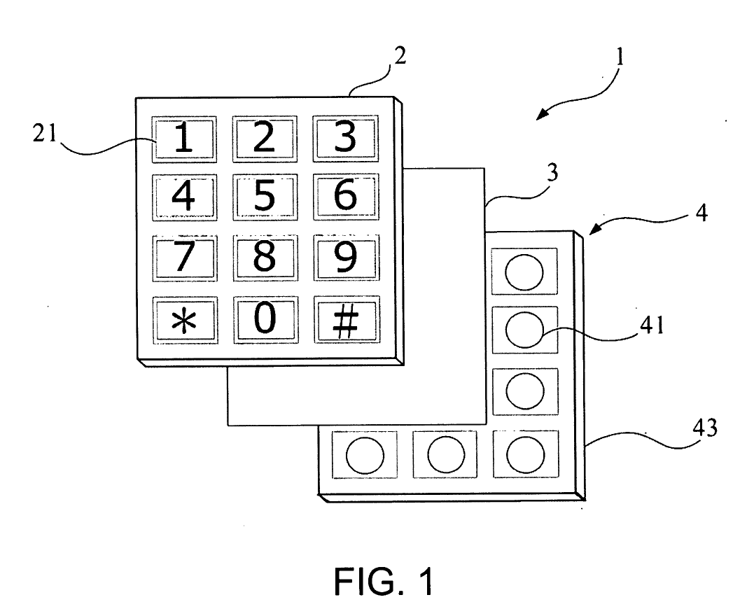

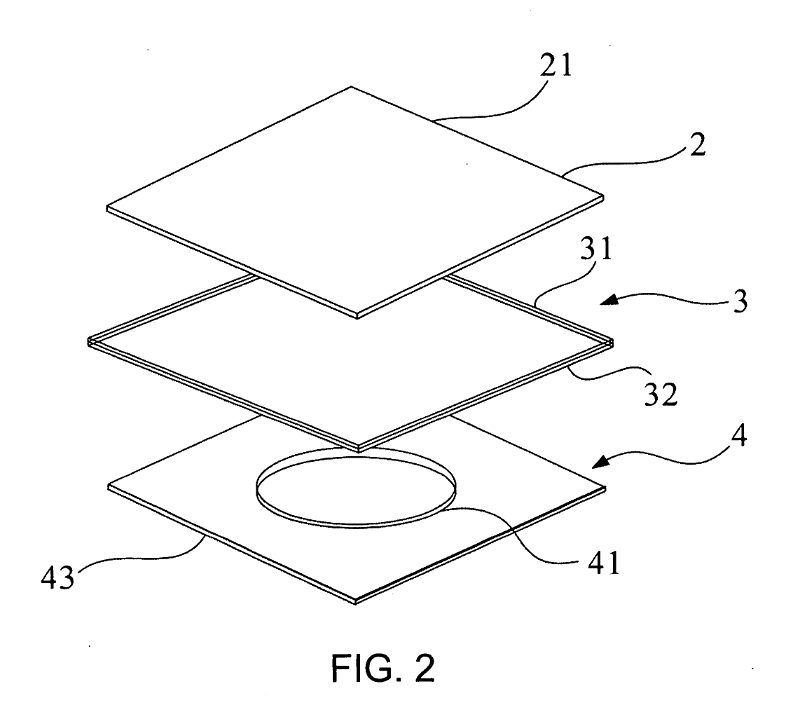

Please refer to FIG. 1 and FIG. 2, which are a structural view and a partial structural view of a first preferred embodiment according to the present invention. As shown in the figures, the p resent invention is a key touch pad module 1, comprising an insulating material area 2, a soft touch pad 3 and a key set 4. The soft touch pad 3 is covered by the insulating material area 2; the key set is covered by the soft touch pad 3; and, each conductive rubber cap 41 of the key set 4 is corresponding to a key area 21 of the insulating material area 2, as shown in FIG. 2. With the above structure, a novel key touch pad module is obtained. Therein, the key area 21 comprises at least a print of a digit, a signal, a character or a figure. The key set 4 comprises the conductive rubber cap 41 and a PCB switch 43; or is substituted with a feel element. The soft touch pad 3 comprises a non-conductive area 31 and a conductive area 32. The non-conductive area 31 comprises a transmittance between 75% and 100%; and the conductive area 32 comprises a transmittance between 0% and 80%. The soft touchpad 3 is an FPC (flexible printed circuit) or is made of a membrane, which is penetrable, light-weighted and deformable. The soft touchpad 3 is stuck to and between the insulating material area 2 and the key set 4 to be applied in the key touchpad module 1 to obtain a touching feeling, a uniform light transmission, and a linear touching sensibility.

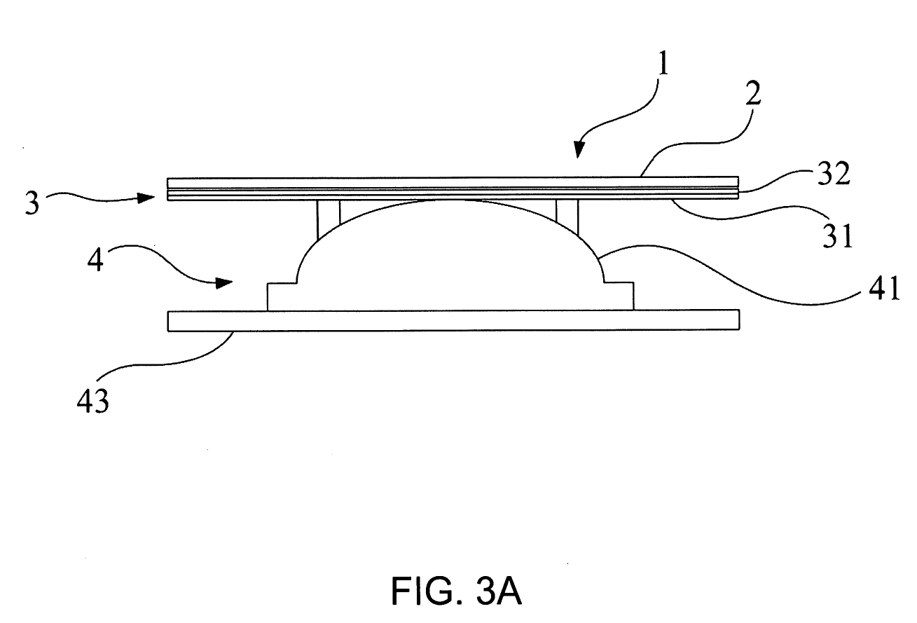

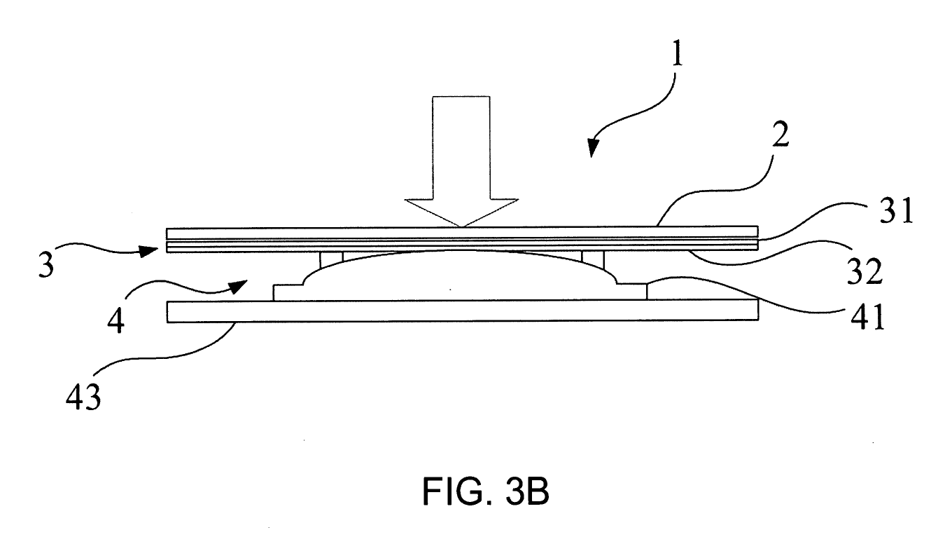

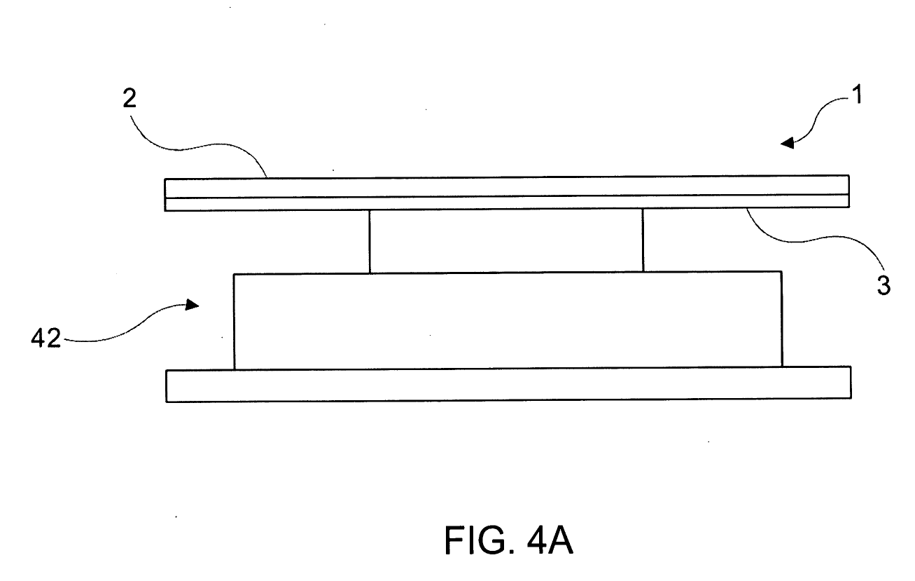

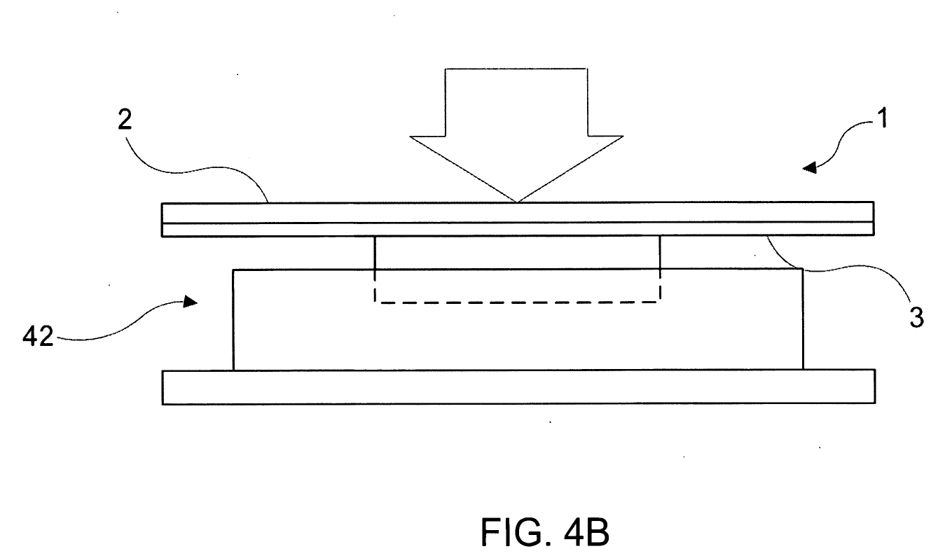

Please refer to FIG. 3A and FIG. 3B, which are a partial cross-sectional view and a partial state-of-use view of the first preferred embodiment according to the present invention. As shown in the figures, when using a key touchpad module 1 according to the present invention, a finger of a user presses on a key area (not shown in the figures) of an insulating material area 2 to deform a soft touchpad 3 for touching a conductive rubber cap 41 so that a contact on the PCB switch is touched to obtain a circuit, where the conductive rubber cap 41 is corresponding to the key area. The key set outputs a corresponding key value; or, the corresponding key value can be obtained from a coordinate value of the soft touchpad 3. Hence, a substantiality of the conductive rubber cap 41 is felt by the user; and, a non-linear problem with the touchpad sensibility is improved while a soft touch pad 3 made of a proper material is selected to smoothly and uniformly transmit light of a LED (light emitting diode) from a non-conductive area 31 of the soft touch pad to the key area of the insulating material area 2. Please refer to FIG. 4A and FIG. 4B, which are a partial cross-sectional view and a partial state-of-use view of a second preferred embodiment according to the present invention. As shown in the figures, a key set can be a feel element 42 for a user to obtain a touching feeling on using the present invention.

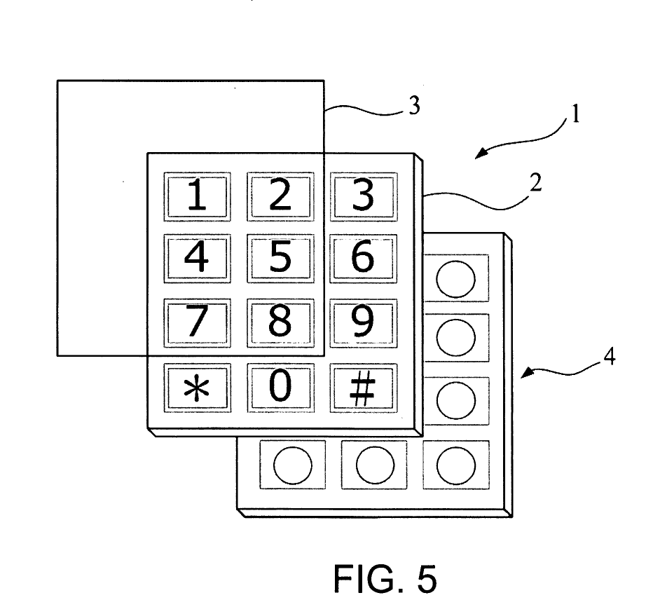

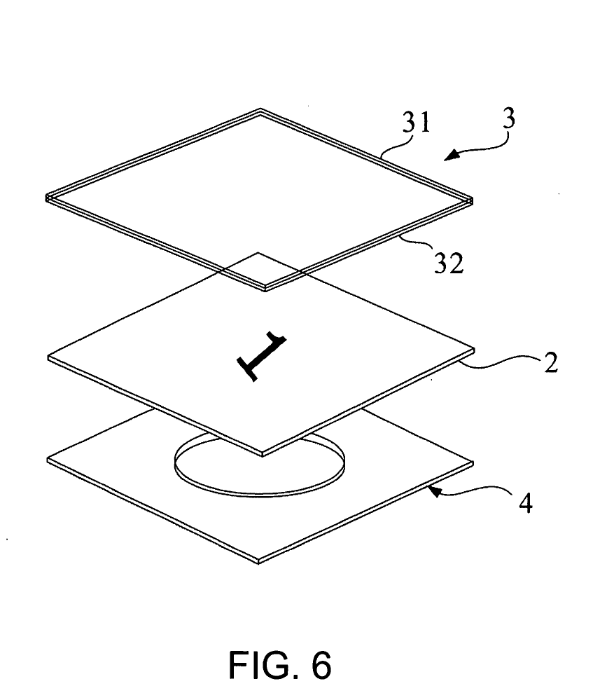

Please refer to FIG. 5 and FIG. 6, which are a structural view and a partial structural view of a third preferred embodiment according to the present invention. As shown in the figures, a key touchpad module 1 comprises a layer of a soft touchpad 3 on top and a layer of a key set 4 at bottom while deposing a layer of an insulating material area 2 between the soft touch pad 3 and the key set 4. Therein, the soft touchpad 3 comprises a non-conductive area 31 and a conductive area 32. Each of the non-conductive area 31 and the conductive area 32 comprises a transmittance between 75% and 100%. The soft touch pad 3 further comprises a key-simulation function.

To sum up, the present invention is a key touch pad module, where a uniform penetrability for keys, a touching feeling and a better linear touching sensibility are obtained.

The preferred embodiment herein disclosed is not intended to unnecessarily limit the scope of the invention. Therefore, simple modifications or variations belonging to the equivalent of the scope of the claims and the instructions disclosed herein for a patent are all within the scope of the present invention.

What is claimed is:

1. A key touch pad module, comprising:
(a) an insulating material area comprising at least one key area on a surface of said insulating material area;
(b) a soft touchpad being covered by said insulating material area; and
(c) a key set comprising at least one conductive rubber cap and a PCB switch, said key set being covered by said soft touchpad, said conductive rubber cap corresponding to said key area of said insulating material area.

2. The key touchpad module according to claim 1, wherein said key area comprises at least a print selected from a group consisting of a digit, a signal, a character and a figure.

3. The key touch pad module according to claim 1, wherein said soft touchpad is made of a material selected from a group consisting of an FPC (flexible printed circuit) and a membrane.

4. The key touchpad module according to claim 1, wherein said soft touchpad comprises a conductive area and a non-conductive area.

5. The key touch pad module according to claim 4, wherein said conductive area comprises a transmittance between 0% and 80%

6. The key touchpad module according to claim 4, wherein said non-conductive area comprises a transmittance between 75% and 100%.

7. The key touchpad module according to claim 1, wherein said soft touchpad further comprises a key-simulation function.

8. The key touchpad module according to claim 1, wherein said key set outputs a corresponding key value.

9. The key touchpad module according to claim 8, wherein said key value is obtained from a coordinate value of said soft touch pad.

10. The key touch pad module according to claim 1, wherein said key set is a feel element.

11. A key touch pad module, comprising:
(a) a soft touchpad;
b) an insulating material area being covered by said soft touch pad, said insulating material area comprising at least one key area on a surface of said insulating material area; and
(c) a key set comprising at least one conductive rubber cap and a PCB switch, said key set being covered by said insulating material area, said conductive rubber cap corresponding to said key area of said insulating material area.

12. The key touchpad module according to claim 10 wherein said soft touchpad is made of a material selected from a group consisting of an FPC (flexible printed circuit) and a membrane.

13. The key touch pad module according to claim 10, wherein said soft touch pad comprises a conductive area and a non-conductive area.

14. The key touch pad module according to claim 13, wherein said conductive are a comprises a transmittance between 75% and 100%.

15. The key touchpad module according to claim 13, wherein said non-conductive area comprises a transmittance between 75% and 100%.

16. The key touchpad module according to claim 10 wherein said soft touchpad further comprises a key-simulation function.

17. The key touchpad module according to claim 10, wherein said key area comprises at least a print selected from a group consisting of a digit, a signal, a character and a figure.

18. The key touch pad module according to claim 10, wherein said kept set outputs a corresponding key value.

19. The key touch pad module according to claim 18, wherein said key value is obtained from a coordinate value of said soft touch pad.

20. The key touch pad module according to claim 10, wherein said key set is a feel element.
